(19) United States
(12) Patent Application Publication
(10) Pub. No.: US 2008/0128215 A1
(43) Pub. Date: Jun. 5, 2008

(54) Portable Scissor Lift

(76) Inventor: Gershon Nowitz, Osprey, FL (US)

Correspondence Address: BOND, SCHOENECK & KING, PLLC, ONE LINCOLN CENTER, SYRACUSE, NY, 13202-1355, US

(21) Appl. No.: 11/943,153

(22) Filed: Nov. 20, 2007

(30) Foreign Application Priority Data
May 24, 2006 (US) PCT/US06/20112

(51) Int. Cl. B66B 9/16

(52) U.S. Cl. 187/243

(57) ABSTRACT

A lift apparatus generally comprising a base unit, wheels rotatably mounted to the base unit, a handle fastened to the base, a scissor lift mounted to the upwardly facing surface of the base unit, and a horizontally extending platform mounted to the upper ends of the lift. The platform is selectively movable along a vertical axis by actuation of the lift by the user. The platform may include extension platforms hingedly associated therewith in order to increase the effective surface area of the apparatus.

### CROSS-REFERENCE TO RELATED APPLICATIONS

The present application is the National Stage Filing of PCT/US06/020112 which claimed priority to Provisional Application Ser. No. 60/594,974, filed May 24, 2005 and the entirety of which is hereby incorporated by reference.

### BACKGROUND OF THE INVENTION

The present invention relates to scissor lifts, and more particularly to scissor lifts useful for moving heavy objects from one location to another.

Traditional sifts are useful for raising and lowering heavy objects and are well known in the art. However, consumers of particularly heavy objects in a retail setting are generally relegated to using wheeled carts to move their purchases with. Once on the cart, it is relatively easy for the consumer to move the products around the store. However, loading the object onto the cart is an oftentimes difficult task requiring the assistance of others, such as store personnel to help pick up and place the object onto the cart.

It is therefore a principal and advantage object of the present invention to provide a lift apparatus that includes a platform onto which heavy objects can be placed, and wheels to provide for the lift's mobility.

Other objects and advantages of the present invention will in part be obvious, and in part appear hereinafter.

### SUMMARY OF THE INVENTION

In accordance with the foregoing object and advantage, the present invention provides a lift apparatus generally comprising a base, wheels rotatable mounted to the base, a handle fastened to the base, a scissor lift mounted to the upwardly facing surface of the base, and a horizontally extending platform mounted to the upper ends of the lift. The platform is thus selectively, vertically movable by the user.

The platform may include extension flaps that effectively increase the workable surface area onto which an object can be placed.

### BRIEF DESCRIPTION OF THE DRAWINGS

The present invention will be more fully appreciated and understood by reading the following Detailed Description in conjunction with the accompanying drawings, in which:

FIG. 1 is a schematic view of portable scissor lift apparatus with an object positioned on the platform thereof; and

FIG. 2 is a perspective view of the scissor lift illustrating the telescoping handle and extension flaps.

### DETAILED DESCRIPTION

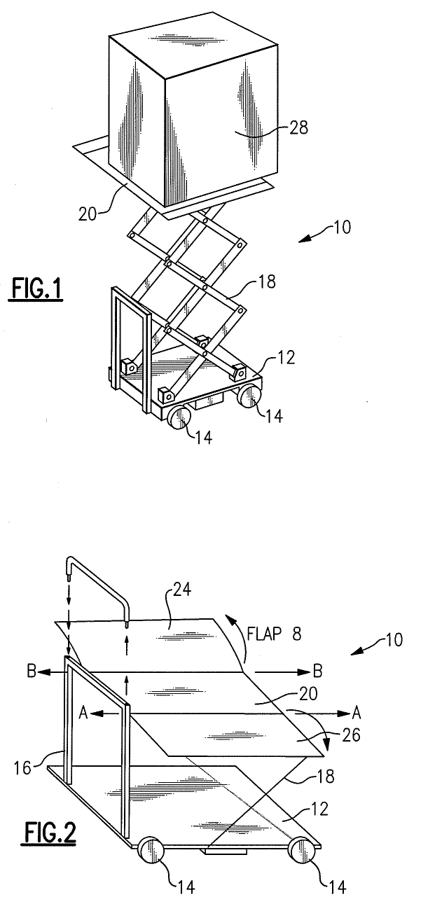

Referring now to the drawings, in which like reference numbers represent like parts throughout, there is seen in FIG. 1 a lift apparatus designated generally by reference numeral 10. Lift apparatus 10 generally comprises a base 12 having front and rear wheels 14 rotatably mounted to the bottom thereof, a handle 16 mounted to and extending upwardly from one end of base 12, a conventional scissor lift 18 mounted to the upwardly facing surface of base 12, and a platform 20 mounted to the upper ends of lift 18.

Wheels 16 can be conventional casters that permit a user to easily turn apparatus 10 while maneuvering. Alternatively, wheels 14 can be conventional rubber wheels mounted to the ends of front and rear axles, either of which can provide for steering of apparatus 10. In addition, for safety reasons locks/brakes 22 are provided to prevent inadvertent moving of apparatus 10 (needs to be shown if this is contemplated).

Handle 16 is rectangularly shaped with its downwardly extending arms being fastened at their bottoms to base 12. It is contemplated that the upper portion of handle 156 can comprise a tubular member that telescopically engages the downwardly extending arms, thereby permitting the height of handle 16 to be selectively adjusted along a vertical axis. Manually set pins, cotter pins, or spring biased pins, or other interconnect member may be used in a manner well known in the art to fix the relative position of handle 16.

Scissor lift 18 is conventional in that it includes laterally adjacent sets of linkages. The linkages pivot about their central mounting point relative to one another thereby being selectively vertically adjustable. Conventional motors may be employed to actuate the raising and lowering of the lift; for example, a hydraulic pump and motor or electric motor.

Platform 20 is securely mounted to the upper end of lift 18 and extends in a generally horizontal plane, and includes a pair of extensions 24, 26 that pivot about longitudinal axes A-A and B-B. Extensions 24, 26 can either be positioned in overlying relation to platform 20 or extend in a common horizontal plane as platform 20, thereby increasing the effective surface area of the platform. Hinge type brackets or other conventional connectors may be used to interconnect and reinforce the connection between extensions 24, 26 and platform 20.

Platform 20 permits large boxes or other heavy objects to be placed thereon and moved about a particular area, such as a store. For instance, a store customer may purchase a lawn mower or similar large, heavy product 28, bring apparatus 10 to the location within the store where object 28 is located, raise/lower lift 18 such that platform 20 extends at about the same horizontal level as object 28, utilize extensions 24, 26 if necessary to increase surface area, slide object 28 onto platform 20, move apparatus 10 to a check out counter, move object 28 to the customer's car, lower or raise lift 18 if necessary, and slide object 28 off of platform 20 and into his/her car.

What is claimed is:

1. A lift apparatus, comprising:
a. a base unit having upper and lower surfaces;
b. a plurality of casters mounted to said lower surface of said base unit;
c. a platform having a planar upper surface and being interconnected to said base unit; and
d. a selectively, vertically adjustable mechanism interconnecting said platform to said base unit and permitting said platform to be selectively moved along a vertical axis.

2. The lift apparatus according to claim 1, further comprising a first platform extension hingedly connect to said platform adapted for selective movement into co-planar relation to said platform.

3. The lift apparatus according to claim 2, further comprising a second platform extension hingedly connected to said platform and adapted for selective movement into co-planar relation to said platform.

4. The lift apparatus according to claim 3, wherein said firs and second platform extensions are connected to said platform at opposing edges thereof

5. The lift apparatus according to claim 2, wherein said vertically adjustable mechanism is a scissor lift.

6. The lift apparatus according to claim 1, further comprising a handle mounted to and extending upwardly from said base unit.

7. The lift apparatus according to claim 6, wherein said handle includes a handle portion telescopically engaged with a handle arm fastened to said base unit, whereby said handle is selectively adjustable along a vertical axis.
